(19) United States
(12) Patent Application Publication
(10) Pub. No.: US 2010/0100626 A1
(43) Pub. Date: Apr. 22, 2010

(54) METHODS AND APPARATUS RELATED TO INTER-WIDGET INTERACTIONS MANAGED BY A CLIENT-SIDE MASTER

(76) Inventors: Stewart O. Allen, Vienna, VA (US); Scott F. Cosby, Alexandria, VA (US); John A. Fath, Falls Church, VA (US); Matthew J. Keesan, Washington, DC (US); Richard S. Labarca, Bayport, NY (US); Hooman Radfar, Arlington, VA (US); Carlos F. Reverte, Arlington, VA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/560,159

(22) Filed: Sep. 15, 2009

Related U.S. Application Data
(60) Provisional application No. 61/097,098, filed on Sep. 15, 2008.
(60) Provisional application No. 61/097,094, filed on Sep. 15, 2008.

(51) Int. Cl. G06F 15/16

(52) U.S. Cl. 709/227

(57) ABSTRACT

In one embodiment, a method includes receiving at a first widget executing at a first client a first signal sent from a second widget executing at a second client. The first signal can be associated with an interactive session between at least the first widget and the second widget. The first widget can be selected to operate as a client-side master. The method can also include defining at the first widget, and based on the first signal, a second signal having a master flag. The second signal can be sent from the first widget to the second widget.

### CROSS-REFERENCE TO RELATED PATENT APPLICATIONS

This patent application claims priority to and the benefit of U.S. Patent Application No. 61/097,098 entitled “Methods and Apparatus related to Inter-Widget Interactions Managed by a Client-Side Master” and filed on Sep. 15, 2008, which is incorporated herein by reference in its entirety.

This patent application is also related to co-pending U.S. Application No. 61/097,094, filed on Sep. 15, 2008, entitled, “Methods and Apparatus for Management of Inter-Widget Interactions,” and related to co-pending U.S. Application bearing attorney docket no. CLEA-007/01US 307269-2023, filed on Sep. 15, 2009, entitled, “Methods and Apparatus for Management of Inter-Widget Interactions,” both of which are incorporated by reference herein in their entireties.

### BACKGROUND

Embodiments relate generally to the behavior of widgets, and, in particular, to methods and apparatus for management of inter-widget interactions.

The world wide web is a platform that has been used to exchange various forms of widgets including videos, images, text, music, applications, etc. Although various known methods of “viral” distribution have been developed to provide users with the capability to spread widgets to other users, these known methods have many shortcomings. For example, many known methods are limited in their ability to provide for the exchange of information between widgets and/or services associated with widgets. Thus, a need exists for methods and apparatus related to management of inter-widget interactions.

### SUMMARY

In one embodiment, a method includes receiving at a first widget executing at a first client a first signal sent from a second widget executing at a second client. The first signal can be associated with an interactive session between at least the first widget and the second widget. The first widget can be selected to operate as a client-side master. The method can also include defining at the first widget, and based on the first signal, a second signal having a master flag. The second signal can be sent from the first widget to the second widget.

### BRIEF DESCRIPTION OF THE DRAWINGS

FIG. 1 is a schematic block diagram that illustrates widgets configured to communicate via a communication channel established using a channel host, according to an embodiment.

FIG. 2 is a schematic block diagram that illustrates a widget configured to operate as a client-side master, according to an embodiment

FIG. 3 is a schematic block diagram that illustrates widgets configured to communicate via a communication channel established using a channel host, according to an embodiment.

FIG. 4 is a flowchart that illustrates a method related to client-side master widget selection and operation, according to an embodiment.

### DETAILED DESCRIPTION

Two or more widgets (e.g., a set of widgets) executing within one or more content aggregation points (CAPs) at one or more network entities can be configured to interact (e.g., communicate) with one another via a channel (e.g., a communication channel). Communication between the widgets can be referred to as inter-widget communication and can be performed via one or more signals transmitted between the widgets based on one or more protocols (e.g., Internet Protocol, a proprietary communications protocol). The signals transmitted by widgets during inter-widget communication can be referred to as inter-widget signals. In some embodiments, the inter-widget communication can be associated with an interactive session between the widgets such as a gaming session and/or a communication session (e.g., a chat session). A time period of inter-widget communication can be referred to as an inter-widget communication session.

In some embodiments, at least a portion of the communication channel can be established (and/or managed) within a network by a channel host. In some embodiments, the channel host can be a widget, a network entity (an application at the network entity), a content aggregation point, and/or a remote channel host within a network. In some embodiments, the communication channel can be established using a function served to one or more channel hosts (e.g., a widget), for example, in response to a request. In some embodiments, the communication channel can be referred to as a communication link. In some embodiments, the communication channel can operate as a bus (e.g., an ordered bus) or operate substantially similar to a bus.

During an inter-widget communication session between widgets, a single widget from the widgets can be selected to operate as (e.g., function as) a master while executing at a client rather than an application at, for example, a server operating as the master. The widget selected as the master can be referred to as a client-side master widget or as a master widget. The widget can be selected as the master based on one or more conditions. The master widget can be configured to manage one or more portions of an inter-widget communication session (e.g., application level signaling). The master widget can be configured to, for example, manage a global state of the inter-widget communication session and/or can order the exchange of content of inter-widget signals within the inter-widget communication session. In some embodiments, multiple widgets can share, or individually execute, at least a portion of one or more functions of a master widget.

One or more widgets can be served from a widget server to the content aggregation point for execution in response to a reference(s) to the widget(s) being accessed at the content aggregation point. The widget(s) can be virally spread to and/or placed at the content aggregation point(s). A widget(s) is virally spread when the widget is associated with (e.g., a reference to the widget is placed at, the widget is executed at) and/or configured to be associated with a content aggregation point in response to a sharing request associated with an instance of the widget at a different content aggregation point. More details related to viral sharing of widgets are set forth in co-pending U.S. application Ser. No. 11/537,362, filed on Sep. 29, 2006, entitled “Method and Apparatus for Widget-Container Hosting and Generation;” co-pending U.S. application Ser. No. 11/537,375, filed on Sep. 29, 2006, entitled “Method and Apparatus for Widget Container/Widget Tracking and Metadata Manipulation;” co-pending application No. 60/977,544, filed on Oct. 4, 2007, entitled “Method and Apparatus for Widget Sharing Between Content Aggregation Points;” and co-pending application Ser. No. 12/244,606, filed on Oct. 2, 2008, entitled “Method and Apparatus for Widget Sharing Between Content Aggregation Points;” all of which are incorporated herein by reference in their entireties.

At least a portion of the widgets and/or at least a portion of one or more functions (e.g., service modules, widget-container functions, applications) associated with the widgets can be executed within one or more content aggregation points at one or more network entities before the inter-widget communication commences. In other words, the widgets can communicate via inter-widget signaling while executing within one or more content aggregation points at one or more network entities. In some embodiments, a widget can be configured to invoke various functions (e.g., service modules, widget-container functions) after being served to the widget and/or can invoke various functions (which can reside at a host (e.g., a widget sharing host)) via an application programming interface (API). In some embodiments, one or more portions of the function(s) can be referred to as a kernel.

The widgets can be configured to transmit (e.g., exchange), via inter-widget communication, information that can be used, for example, to cause an action related to a widget (e.g., modification of execution of one or more of the widgets and/or one or more service modules associated with the widgets). In some embodiments, one or more of the widgets can be configured to use inter-widget signaling to request and/or transmit (e.g., send, broadcast) an indicator related to the availability/functionality to engage in inter-widget communication.

The master widget and/or a channel host can be configured to track (e.g., collect, store, process, and/or transmit (e.g., push)) and/or trigger tracking of inter-widget interactions related to an inter-widget communication session. In some embodiments, one or more portions of inter-widget communication between widgets and/or resulting behavioral changes (e.g., triggered actions) of the widget(s) can be tracked. In other words, information related to one or more portions of inter-widget communication between widgets can be tracked. In some embodiments, a user-triggered interaction with a widget (e.g., an interaction of a user (via a user interface) with a widget) can also be tracked. The tracked inter-widget communication parameter values (e.g., inter-widget communication parameter values related to user-triggered interactions) can be, for example, processed to identify one or more trends related to the inter-widget communication and/or to cause an action (e.g., a behavioral change) related to a widget.

A content aggregation point can be, for example, managed by (e.g., hosted at, served from) and/or executed at the network entity and can be, for example, a desktop, a start page, a wireless application protocol (WAP) gallery, a gallery, a processor-readable vehicle (e.g., a webpage), a portal, and/or a directory. A network entity configured to manage a content aggregation point can be referred to as a content aggregation point server. WAP galleries, web galleries, and so forth are types of content aggregation points that can be referred to as content distribution points. In some embodiments, a content aggregation point can be referred to as a content aggregation location or as a content aggregation site.

In some embodiments, a widget can be associated with (e.g., contained in, integrated in, referenced within) a widget container (also can be referred to as a container) when, for example, shared with (e.g., placed at) a content aggregation point. The widget container can be framework that can include a reference to the widget and can include a service module (e.g., tracking service module, advertisement service module, etc.). More details related to placement of a widget container and/or a widget at a content aggregation point are set forth in co-pending U.S. application Ser. No. 11/682,626, entitled, “Method and Apparatus for Widget and Widget-Container Platform Adaptation and Distribution,” which is incorporated herein by reference in its entirety.

In this written description and the appended claims, the singular forms “a,” “an” and “the” include plural referents unless the context clearly dictates otherwise. Thus, for example, the term “an identifier” is intended to mean a single identifier or a combination of identifiers. In addition, the term “widget,” which is used throughout the written description and the appended claims, can also mean an “instance of a widget.” For example, a widget that is served to a content aggregation point can be an instance of the widget served to the content aggregation point.

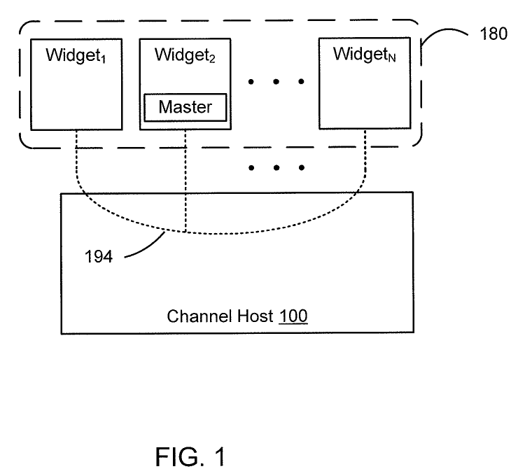

FIG. 1 is a schematic block diagram that illustrates widgets 180 configured to communicate via a communication channel 194 established using a channel host 100, according to an embodiment. Specifically, the widgets 180 (e.g., set of widgets 180) includes widgets 1 through N. As shown in FIG. 1, widget₂ is configured to operate as a master and can be referred to as a master widget. In some embodiments, the widget₂ can be configured to operate as an exclusive master widget so that the role of the master widget is substantially not shared. In some embodiments, other of the widgets 180 (widgets other than widget₂) that are not operating as a master can be referred to as members or as member widgets. In some embodiments, the master widget can also operate as a member widget.

The channel host 100 can be configured to manage portions of inter-widget signaling related to network level signaling associated with an inter-widget communication session (or any other type of inter-widget interactive session) conducted via the communication channel 194. In some embodiments, the network level signaling can be associated with layers 1 through 5 of the open systems interconnection (OSI) model. In other words, the channel host 100 is configured to manage the logistics of the communication channel 194 during the inter-widget communication session such as the distribution of packets to one or more of the widgets 180. In some embodiments, the network level signaling can include portions of inter-widget signaling related to joining the communication channel 194, leaving the communication channel 194, transmitting (e.g., broadcasting, pushing) information on the communication channel 194, writing information to a memory via the communication channel 194, and/or receiving (e.g., getting) information from the communication channel 194. In some embodiments, the channel host 100 can order one or more network level signals from one or more of the widgets 180.

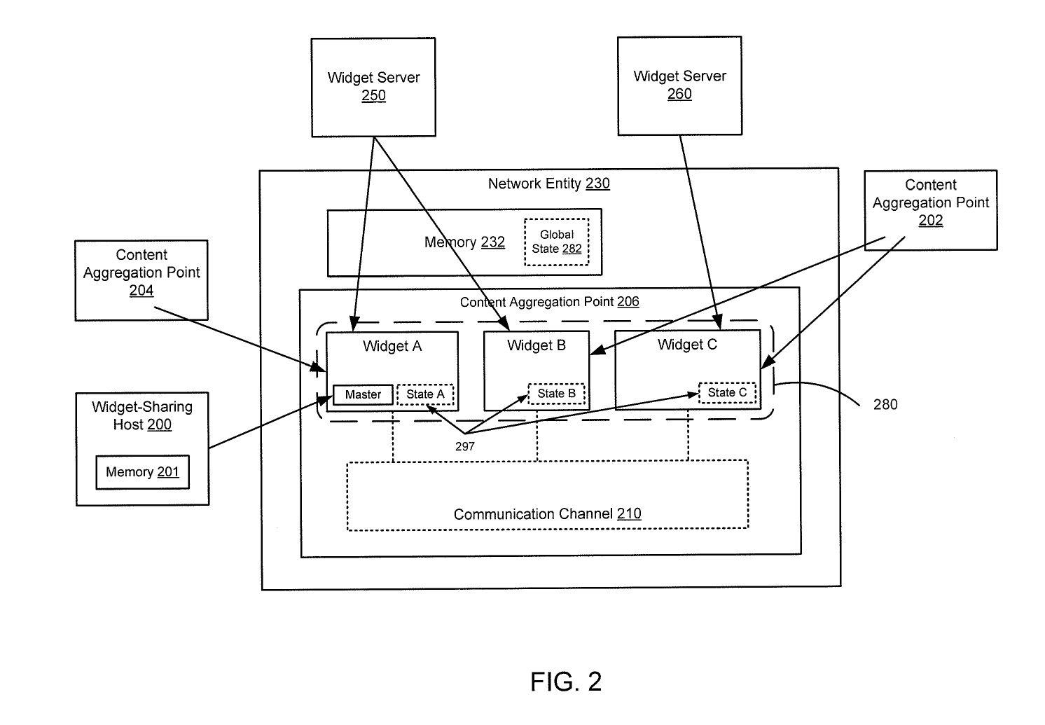

The master widget (widget₂) can be configured to manage portions of inter-widget signaling related to application level signaling (e.g., manage an attribute associated with application level signaling) associated with an inter-widget communication session (or any other type of inter-widget interactive session) conducted via the communication channel 194. In some embodiments, the application level signaling can be signaling associated with layers 6 through 7 of the open systems interconnection (OSI) model. In other words, the master widget can be configured to manage portions of inter-widget signaling related to applications associated with the widgets 180 (e.g., communication state) and/or semantic communications between the widgets 180 during the inter-widget communication session. For example, the master widget can be configured to manage the global state of an inter-widget communication session between the widgets 180. More details related to management of a state of an inter-widget communication session are discussed in connection with FIG. 2.

In some embodiments, the network level signaling and the application level signaling can be defined based on different protocols. For example, the network level signaling can be based on a communication protocol such as Ethernet protocol while the application level signaling can be defined based on a proprietary signaling protocol associated with one or more applications used by the widgets 180. In some embodiments, the network level signaling and the application level signaling can be encoded into a single signaling protocol. In some embodiments, the application level signaling can be encoded within a payload and/or a different portion of, for example, an Ethernet packet transmitted over the communication channel 194. The Ethernet packet can be routed by the channel host 100 based on an Ethernet protocol.

An inter-widget signal transmitted by widget₂ when operating in its role as a master widget can be referred to as a master inter-widget signal or as a master signal. The inter-widget signal from the master widget can have an indicator (e.g., a flag) that can be used to identify the inter-widget signal as a master signal. In some embodiments, the indicator can be referred to as a master indicator. In some embodiments, an inter-widget signal from a member widget can be referred to as a member inter-widget signal.

Although not shown, the channel host 100 can be, for example, one or more widgets, content aggregation points, network entities, and/or servers (e.g., a remote server). In other words, at least one or more tasks performed by the channel host 100 can be performed by one or more widgets, content aggregation points, network entities, and/or servers. Although not shown in this embodiment, the channel host 100 can be a widget and/or at least a portion of task that can be performed by the channel host 100 can be performed by a widget.

The channel host 100 can be configured to establish at least a portion of the communication channel 194. The communication channel 194 can be established within a network, which can include one or more wired and/or wireless segments. In some embodiments, the communication channel 194 can be established based on an available channel, in an ad-hoc fashion, and/or a channel that has been reserved (e.g., a pre-determined channel) for use by each widget from the widgets 180. More details related to apparatus and methods for establishing a communication channel are set forth in co-pending U.S. Application No. 61/097,094, filed on Sep. 15, 2008, entitled, “Methods and Apparatus for Management of Inter-Widget Interactions,” and co-pending U.S. Application bearing attorney docket no. CLEA-007/01US 307269-2023, filed on Sep. 15, 2009, entitled, “Methods and Apparatus for Management of Inter-Widget Interactions,” both of which are incorporated by reference herein in their entireties. After the communication channel 194 has been established, one or more of the widgets 180 can be configured to engage in inter-widget communication via the communication channel 194.

Although not shown, one or more of the widgets 180 can be executing within one or more content aggregation points associated with one or more network entities. For example at least a portion of widget₁ and widget₂ can be executing at a first content aggregation point at a first network entity, and at least a portion of widget_{N} can be executing at a second content aggregation point at a second network entity. In some embodiments, for example, at least a portion of widget₁ and widget₂ can be executing at a first content aggregation point and a second content aggregation point, respectively, which are both at a first network entity. At least a portion of widget_{N} can be executing at a third content aggregation point at a second network entity.

Each of the widgets can be any type of object such as a static data object (e.g., a text-based object), a media object (e.g., a video, an mp3, or an image), and/or a software object (e.g., a javascript applet, a rich media object) that can be executed (e.g., displayed, manipulated) at one or more content aggregation points associated with, for example, a network entity. The network entity can be a wired device and/or a wireless device such as, for example, a computer (e.g., a computing device), a mobile phone, a personal digital assistant (PDA), and/or a server. The network entity can be configured with one or more platforms that can include on one or more types of hardware, architecture, software, operating systems, runtime libraries, and so forth.

The master widget can be selected to operate as the master based on one or more conditions (e.g., criteria). In some embodiments, for example, the master widget can be selected to operate as the master based on a timing with which the master widget joins an inter-widget communication session. For example, if the master widget initiated an inter-widget communication session and/or is the first member of an inter-widget communication session, the master widget can be selected as the master of the inter-widget communication session. In some embodiments, the master widget can be selected to operate as the master based on a networking capacity associated with the master widget. For example, the master widget can be selected as the master because the master widget is executing at a network entity that has a signaling bandwidth that exceeds a specified threshold, or is higher than a signaling bandwidth associated with any of the other widgets 180. In some embodiments, the master widget can be randomly or periodically (based on a specified time period) selected as the master. In some embodiments, the master widget can be selected as the master of the inter-widget communication session in response to a different widget (from the widgets 180) leaving an inter-widget communication session.

One or more of the conditions used for selection can be stored in and/or accessed from a memory (not shown) associated with the channel host 100, a widget server (not shown), a content aggregation point (not shown), a network entity (not shown), and/or any of the widgets 180. In some embodiments, the channel host 100, the widget server, the content aggregation point, the network entity, and/or any of the widgets 180 can be configured to determine (e.g., negotiate) which of the widgets 180 should be selected as the master based on condition(s) accessed from the memory. In some embodiments, the master widget can be selected to operate as the master of the inter-widget communication session in response to volunteering to operate as the master, for example, before another of the widgets 180 volunteers to operate as the master.

In some embodiments, one of the widgets 180 can be selected to operate as the widget master based on whether or not the master is capable of functioning as the master. For example, the master widget can be queried (e.g., queried by a channel host such as channel host 100) with respect to access to (e.g., potential access to, actual access to) one or more functions that may be needed to operate as the master widget before being selected as the master widget. The selection of the master widget can be contingent on a response from the master widget meeting a specified criteria.

In some embodiments, one or more of the widgets 180 can reject an invitation (e.g., an invitation from a channel host such as channel host 100) to operate as a master widget. In some embodiments, one or more of the widgets 180 can be designated (e.g., designated by a channel host such as channel host 100) to operate as a master widget without being provided with an opportunity to decline.

In some embodiments, one or more functions (e.g., the intelligence) used by widget₂ to operate as the master of an inter-widget communication session can be programmed into widget₂ (as part of an application of widget₂ or associated with widget₂) and/or invoked via an API. If invoked via an API, the function(s) can reside at a widget server (not shown), the channel host 100, a content aggregation point (not shown), a network entity (not shown), and/or any of the widgets 180. In some embodiments, if widget₂ does not have one or more of the functions needed to operate as the master, the widget₂ can be configured to fetch the function(s). In some embodiments, widget₂ can be configured to fetch the function(s) in response to being selected as the master of an inter-widget communication session. In some embodiments, widget₂ can be configured to send the function(s) to another of the widgets 180 selected as the master.

In some embodiments, an entity (e.g., the channel host 100) can be triggered to send at least a portion of a function(s) to widget₂ in response to widget₂ being selected to operate as a master an inter-widget communication session associated with communication channel 194. In some embodiments, an indicator that widget₂ has been selected as the master can be used to trigger the entity to the send at least a portion of the function(s). In some embodiments, before sending the portions of the function(s) the entity can query widget₂ to determine whether or not at least a portion of the function(s) should be sent to widget₂. Widget₂ can be configured to respond to the query with information regarding portions of function(s) that should be sent to widget₂ so that it can operate as the master.

Inter-widget signals can be transmitted before and/or after the communication channel 194 has been established. In some embodiments, for example, after widgets 180 have already engaged in inter-widget communication via communication channel 194, inter-widget signals can be transmitted between the widgets 180 so that one or more widgets from the widgets 180 can communicate (e.g., send, declare, request, acknowledge) information related to a presence of (e.g., a status of) and/or a function (or a portion of a function) associated with one or more different widgets from the widgets 180. More details related to inter-widget auto-discovery are discussed in connection with co-pending patent application No. 61/097,094 and co-pending U.S. Application bearing attorney docket no. CLEA-007/01US 307269-2023, both of which have been incorporated by reference herein in their entireties. In some embodiments, an inter-widget signal can be sent to a specific widget (or subset of widgets) and/or can be broadcast within network 170. Inter-widget signaling after the communication channel 194 has been established can be transmitted using the communication channel 194 and/or can be transmitted via an out-of-band communication link.

Widget₂ can be configured to operate as a master of inter-widget communication between the widgets 180 even though one or more of the widgets 180 may be executing independent of one another. One or more of the widgets 180 may operate independently when, for example, they are served to one or more content aggregation points 190 at different times, are controlled by different entities, operate based on different platforms, are not aware of one another before being served, and/or are not specifically configured to operate together (e.g., operate in concert) as applications that are dependent on one another (except for via inter-widget communication and/or an API related to inter-widget communication). For example, even though widget₁ and widget_{N} can both be configured to execute within a single content aggregation point (not shown), widget₁ and widget_{N} can be independently operating widgets that are served from different widget servers (not shown).

In some embodiments, the widgets 180 can be configured to exchange inter-widget signals despite being configured to operate (e.g., execute, communicate) based on different protocols, platforms, and so forth. For example, the widgets 180 can be programmed based on different platforms that are not compatible with one another. However, the widgets 180 can be configured to define and exchange at least inter-widget signals based on a common inter-widget signaling protocol.

In some embodiments, one of the widgets 180 operating based on a platform can be configured to access (e.g., invoke via an API, request and receive) a translation function (not shown) that the can be used by the widget when engaging in an inter-widget communication session with another widget 180 that is configured to operate based on a different platform. For example, widget₁ can be configured to process (e.g., produce) inter-widget signals based on a first protocol that is incompatible with a second protocol used by widget_{N}. Widget₁ can be configured to access a translation function to translate inter-widget signals produced by widget₁ based on the first protocol into inter-widget signals based on the second protocol so that the inter-widget signals will be compatible with widget_{N}. Widget₁ can also be configured to invoke the translation function to translate inter-widget signals produced by widget_{N} and based on the second protocol into inter-widget signals that can be compatibly processed by widget₁.

In some embodiments, the widget master can be configured to act as a mediator of at least one or more interactions (e.g., inter-widget signals) between widgets 180 operating based on different platforms. For example, the widget master can be configured to translate ingress inter-widget signals and/or egress inter-widget signals for one or more of the widgets 180 into one or more different protocols. In some embodiments, the master widget can be configured to distribute information related to one or more widgets 180 with respect to platforms (e.g., protocols) used by each to engage in inter-widget interactions. One or more widgets 180 can use the platform information to access a translation function that can be used to engage in compatible inter-widget interactions with another of the widgets 180. The master widget can distribute such information periodically, on demand, in response to a request, based on a subscription, when a widget becomes available (e.g., is served to a content aggregation point), and so forth.

In some embodiments, one or more widgets 180 operating based on different platforms can be configured to negotiate a particular platform that can be used for an inter-widget interaction (e.g., during an inter-widget communication session). In some embodiments, the platform (e.g., protocol) can be selected by the widget master and/or the channel host 100. Although not shown, in some embodiments, the translation function can be configured to access, for example, a database (e.g., a local database, a remote database) with information (e.g., algorithms, look-up tables) that can be used to translate inter-widget interactions between various widget platforms.

FIG. 2 is a schematic block diagram that illustrates a widget (widget A) configured to operate as a client-side master, according to an embodiment. As a client-side master, widget A can be configured to manage at least a portion of inter-widget communications (or any other type of inter-widget interactions) associated with a communication channel 210 established at a content aggregation point 206. Content aggregation point 206 is configured to operate as a host of the communication channel 210. Specifically, widget A can be configured to manage application level inter-widget communications transmitted between widget A, widget B, and widget C. Because widget A is configured to operate as a client-side master, widget A can be referred to as master widget A.

At least a portion of widget A, widget B, and widget C are executing within content aggregation point 206. Content aggregation point 206 is associated with network entity 230. Widget C is served for execution within content aggregation point 206 from widget server 260. Specifically, an instance of widget C can be served from widget server 260 for execution within content aggregation point 206 in response to a reference (not shown) to widget C being accessed at content aggregation point 206. The reference can be automatically accessed or accessed in response to a user-triggered interaction with the reference. Likewise, widget A and widget B are served for execution within content aggregation point 206 from widget server 250. Widget A, widget B, and widget C can collectively be referred to as widgets 280.

As indicated in FIG. 2, widget A has been shared (e.g., virally shared) from content aggregation point 204. Specifically, a reference to widget A has been placed at content aggregation point 206 in response to a sharing request associated with (e.g., initiated at) an instance of widget A executing at content aggregation point 204. Likewise, widget B and widget C have been shared with content aggregation point 206 from content aggregation point 202.

The communication channel 210 through which the widgets 280 engage in inter-widget communication can be established at content aggregation point 206 associated with network entity 230. The communication channel 210 can be established in response to a request from one or more of the widgets 280. The communication channel 210 can be established based on a communication channel function served to the content aggregation point 206 and/or based on a communication channel function integrated into (e.g., programmed within) the content aggregation point 206.

Although widget A is configured to operate as a master widget, widget A can be configured engage in inter-widget communication via the communication channel 210 as a member widget as well. In some embodiments, a widget selected to operate as a master widget can be configured to operate only as a master widget and may not operate as a member widget as well. In some embodiments, a widget selected to operate as a master widget may be prevented from engaging in inter-widget communication as a member widget.

An attribute of application level signaling between the widgets 280 that can be managed by master widget A can be a global state 282 of the application level signaling associated with communication channel 210. The global state 282 can be, for example, a global state of an inter-widget communication session (or any other type of inter-widget interactive session) in which the widgets 280 have engaged. In other words, the global state can be a state for the entire inter-widget communication session. For example, the inter-widget communication session can be related to an interactive a gaming session or a chat session. As shown in FIG. 2, the global state 282 is stored at a memory 232 of the network entity 230. In some embodiments, the global state 282 can be stored at a memory location outside of the network entity 230 (e.g., a remote memory, a memory 201 associated with a widget-sharing host 200, a memory associated with a channel host (not shown), a memory associated with a different network entity (not shown), a widget server (e.g., widget server 250)). In some embodiments, other types of global information (e.g., a global memory with shared information) in addition to state can be managed by master widget A.

Also as shown in FIG. 2, each of the widgets 280 can maintain (e.g., update based on a local state machine) an individual state that is specific to each of the widgets 280. Specifically, widget A, widget B, and widget C can maintain state A, state B, and state C, respectively. In some embodiments, an individual state related to, for example, widget A can be referred to as local state A. State A, state B, and state C can collectively be referred to as local states 297. In some embodiments, one or more of the local states 297 can be stored at, for example memory 232 and/or at a memory location (not shown) outside of the network entity 230. In some embodiments, the widgets 280 can be configured to register with an entity (not shown) configured to control the memory location outside of the network entity 230. In some embodiments, a widget can have multiple local states and a local state can be associated with several widgets.

One or more of the local states 297 can be used by the master widget to produce the global state 282. For example, a change in local state B in response to a user-triggered interaction (via a user interface (not shown)) with widget B can be communicated over the communication channel 210 to master widget A via inter-widget signal 296. Master widget A can determine and update the global state 282. In some embodiments, the change in local state B can trigger several changes in the global state 282 such as changes in a local state of another widget such as local state C of widget C. The global state 282 with the update can be transmitted (e.g., broadcast, pushed) to widget B and/or to widget C. In some embodiments, the global state 282 can be a concatenation of the local states 297 and/or a state that is different than one or more of the local states 297.

In some embodiments, rather than communicating changes to the local states 297 directly to master widget A via the communication channel 210, changes to one or more of the local states 297 can be updated in a storage location (not shown) that can be accessed by master widget A. Master widget A can obtain the updates to the local states 297 from the storage location (e.g., memory 232, a memory location outside of the network entity 230).

In some embodiments, the global state 282 can be stored at a memory location where the content of the global state 282 can persist even if master widget A became unavailable (e.g., unexpectedly became unavailable, was terminated). In this embodiment, if master widget A were terminated, widget B, for example, could be designated to operate as a master widget of an inter-widget communication session. Accordingly, widget B could update the global state 282 of the inter-widget communication session. If necessary, widget B can be configured to receive (e.g., fetch) one or more functions to operate as the master widget.

In some embodiments, the global state 282 can be stored at a remote memory location (e.g., the memory 210 associated with widget-sharing host 200) so that a widget (not shown) engaged in an inter-widget communication session associated with communication channel 210 and executing at a network entity (not shown) other than network entity 230 can maintain the global state 282 of an inter-widget communication session if network entity 230 were to become unavailable. The global state 282 can include information related to a list of member widgets associated with the inter-widget communication session, a history of global states and/or a history of inter-widget signals transmitted by one or more of the widgets 280, and so forth.

In some embodiments, master widget A can be configured to manage at least a portion of an inter-widget communication session associated with multiple communication channels, or multiple inter-widget communication session associated with a single communication channel. For example, master widget A can be configured at least a portion of an inter-widget communication session between the widgets 280 via communication channel 210 and can be configured to handle an inter-widget communication session between widgets 280 or (a different set of widgets) via a different communication channel (not shown).

In addition to global state 282, master widget A can be configured to collect, process, and/or communicate (e.g., push) information to the other widgets 280 the same as or similar to the that used with respect to global state 282. For example, the master widget can receive platform information related to each of the widgets 280 and can store that information at a central location where it can be accessed by each of the widgets 280. In some embodiments, master widget A can collect platform information related to each widget when a new widget (not shown) joins the communication channel 210 and can broadcast the platform information to the widgets 280. In some embodiments, master widget A can be configured to collect, process, and/or communicate (e.g., push) information to the other widgets 280 in response to a change in the information being detected by master widget A or in response to a change (e.g., an indicator of a change) in the information being communicated to master widget A.

In some embodiments, one or more of the widgets 280 can subscribe to receive information (e.g., a notification, data) related to an event related to another widget 180. In some embodiments, the event can be an action, an update, a current event, a future event, a subset of events. In some embodiments, master widget A can be configured to manage subscriptions. For example, widget B can request that widget B be notified when widget C has acquired a particular (or type of) functionality, has calculated a particular (or type of) output parameter value, is ready to receive a particular (or type of) input parameter value, and/or is available to engage in inter-widget communication. Master widget A can be configured to detect (e.g., passively or proactively detect), and/or receive notification of the event, and subsequently notify any of the widgets 180 that are subscribing widgets. In some embodiments, the subscription can be managed by a subscription function associated with an entity (e.g., widget B, widget C, a different widget (e.g., widget B), a channel host (not shown), the widget-sharing host 200, etc.).

In some embodiments, one or more portions of an inter-widget signal can be queued for a period of time. In some embodiments, the queuing of inter-widget signals can be handled by master widget A. In some embodiments, master widget A can detect whether or not an inter-widget signal has been successfully communicated between widgets 280. If the communication has failed, master widget A can queue the inter-widget signal (e.g., hold a copy of the inter-widget signal) until it is resent (e.g., resent by master widget A) and/or trigger one of the widgets to resend the inter-widget signal.

For example, if widget C is unable to respond to an inter-widget signal (e.g., an inter-widget signal defining a request related to the availability/functionality of widget C to engage in inter-widget communication), the inter-widget signal can be queued and transmitted to widget C when widget C becomes available to respond (in response to an indicator). In some embodiments, if widget B had sent the inter-widget signal to widget C, widget B can be triggered to resend the inter-widget signal when widget C is available to respond. In some embodiments, widget B can be triggered by master widget A to resend the inter-widget signal. In some embodiments, the inter-widget signal can be queued for a specified period of time. The inter-widget signal can be purged if widget C does not become available before a specified period of time has expired.

In some embodiments, the queuing of inter-widget signals can be handled by a queuing entity. The queuing entity can be, for example, any widget (e.g., widget B), a channel host (not shown), a content aggregation point, and so forth.

In some embodiments, master widget A can manage inter-widget communications so that inter-widget signals and/or content associated with the inter-widget communications are communicated in a particular order. In some embodiments, for example, the communication channel 210 can be operated as an ordered bus. For example, master widget A can receive inter-widget signals (e.g., inter-widget signals related to one or more local states 297) from one or more widgets 280, and can process the content associated with the inter-widget signals. Master widget A can then broadcast the processed content in a particular order using master signals via the communication channel 210. In some embodiments, for example, multiple master signals (in which the processed content is encoded) can be transmitted in a particular order via the communication channel 210 from master widget A. The channel host (e.g., the content aggregation point 206) of the communication channel 210 can be configured to maintain the ordering of the master signals (and thus the ordering of the processed content). In some embodiments, master widget A can be configured to order content associated with inter-widget signals in a first-in-first-out (FIFO) order, or a different order (e.g., an order based on rank order priority associated with the widgets 280).

In some embodiments, widget A can be configured to share one or more roles associated with operation as a master of an inter-widget communication session associated with communication channel 210 with another of the widgets 280. In some embodiments, the widgets 280 sharing the role(s) of the master can be configured to negotiate how the role(s) of the master should apportioned. For example, widget A can handle updating the global state 282 while widget B can handle communicating the updated global state 282 to the widgets 280. In some embodiments, the widgets 280 sharing the role(s) of the master can be assigned different portions of the role(s) of the master, for example, by a channel host (which in this embodiment is the content aggregation point 206).

In some embodiments, one or more portions of an inter-widget interaction related to the widgets 180 can be tracked (e.g., collected, stored, processed, and/or transmitted). The data that is tracked can be referred to as tracking data or as inter-widget tracking data (when specifically related to an inter-widget interaction). For example, attributes related to inter-widget signals transmitted between widgets over communication channel 194 and/or resulting behavioral changes (e.g., triggered actions) of the widget(s) can be tracked. In some embodiments, a user-triggered interaction with a widget (e.g., an interaction of a user, via a user interface, with a widget) can also be tracked. In some embodiments, The tracked inter-widget communication parameter values (e.g., inter-widget communication parameter values related to user-triggered interactions) can be, for example, processed to identify one or more trends related to the inter-widget communication and/or to cause an action (e.g., a behavioral change) related to a widget.

In some embodiments, the channel host 100 can be configured to track one or more portions of an inter-widget communication session (e.g., an interactive inter-widget communication session) associated with the communication channel 194. As the host of the communication channel 194, the channel host 100 can be configured to manage network level signaling associated with the communication channel 194. Accordingly, the channel host 100 can receive signals (e.g., inter-widget signals) transmitted via the communication channel 194. The channel host 100 can be configured to collect and/or store specified information related to the communication channel 194. The information related to the communication channel 194 can be stored as tracking data. For example, the channel host 100 can be configured to track (e.g., collect and store) the number, content, and/or type of inter-widget signals (e.g., save signals, get signals, query signals, command signals) transmitted by one or more of the widgets 180, user interactions with one or more of the widgets 180, attributes (e.g., type, content, timing, and/or number) of actions of one of the widgets 180 triggered (e.g., caused) by another of the widgets 180, characteristics related to the communication channel 194 (e.g., a duration of the inter-widget communication session, a date-time stamp associated with the inter-widget communication channel), and/or the types of widgets 180 involved in the inter-widget communication session.

In some embodiments, widget₂, in its role as a master widget, can be configured track specified information related to an inter-widget communication session associated with the communication channel 194 (e.g., information related to inter-widget signals transmitted from widget₁). In some embodiments, tracking data that is acquired by widget₂ can be sent to an entity (e.g., the channel host 100) for further processing. In some embodiments, for example, widget₂ can be configured to track an attribute (e.g., a number, an encoded content, a type) of one or more inter-widget signals transmitted between the widgets 180. In other words, widget₂ can track widget activity associated with the communication channel 194. In some embodiments, widget₂ can be configured to track information related to behavioral changes and/or one or more states of one or more of the widgets 180. In some embodiments, widget₂ can track information related to members as they join and/or leave the communication channel 194 (e.g., widget identifiers, placement identifiers associated with widgets, widget types). In some embodiments, widget₂ can be configured to trigger a different entity (e.g., the channel host 100, a content aggregation point (not shown), a widget server (not shown), one of the widgets 180, a network entity (not shown)) to track specified data.

In some embodiments, tracked data (e.g., data tracked by channel host 100, data tracked by widget₂) can be sent to a different entity for storage and/or further processing. In some embodiments, the information can be transmitted using, for example, one or more packets (e.g., packet bursts, regularly scheduled packets). In some embodiments, the information can be transmitted via the communication channel 194. In some embodiments, tracked data can be processed using the apparatus and methods set forth in co-pending U.S. Application No. 61/089,357, entitled, “Methods and Apparatus for Processing Data to Produce a Data Tree,” which is incorporated by reference herein in its entirety.

In some embodiments, information that is tracked during (or after) an inter-widget communication session can be used to modify the behavior of one or more of the widgets 180. For example, information related to messages transmitted between widget₁ and widget_{N} can be used to modify the behavior of widget₂. For example, widget₂ can execute in a different fashion based on an inter-widget signaling trend between widget₁ and widget_{N}. Specifically, widget₂ can be configured to display a particular advertisement/content or execute a particular algorithm based on the content of inter-widget signals transmitted between widget₁ and widget_{N} during a current or terminated inter-widget communication session.

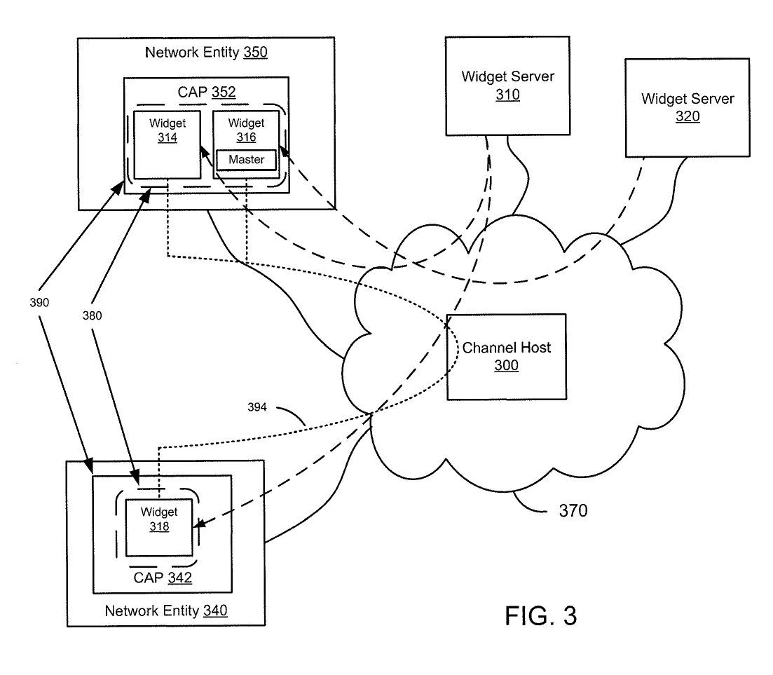

Although FIG. 2 is related to inter-widget communication via communication channel 210, which is a communication channel established within content aggregation point 206 as the channel host, the embodiments described in connection with FIG. 2 can be applied within inter-widget communication via a different communication channel configuration. For example, the embodiments described in connection with FIG. 2 can be applied in connection with a communication channel established between multiple content aggregation points (which could be executing at one or more network entities) and/or multiple network entities using one or more channel hosts. The network entities may be configured to operate based on different platforms (e.g., a personal computer platform vs. a PDA platform). An example of a different communication channel configuration is described in connection with FIG. 3.

FIG. 3 is a schematic block diagram that illustrates widgets 380 configured to communicate via a communication channel 394 established using a channel host 300, according to an embodiment. Specifically, the widgets 380 (e.g., set of widgets 380) include widget 314, widget 316, and widget 318. At least a portion of widget 314 and widget 316 are executing at content aggregation point 352 at network entity 350, and at least a portion of widget 318 is executing at content aggregation point 342 at network entity 340. At least a portion of the communication channel 394 can be established within network 370, which can include one or more wired and/or wireless segments. In some embodiments, the channel host 300 can also function as a widget-sharing host.

As shown in FIG. 3, widget 316 is configured to operate as a master widget of an inter-widget communication session associated with the communication channel 394. The widget 316 can be configured to operate as a master of the inter-widget communication session even though, for example, widget 314 and widget 318 are executing at different content aggregation points (content aggregation point 352 and content aggregation point 342, respectively) and different network entities (network entity 350 and network entity 340, respectively).

The network entity 340 and/or the network entity 350 can have a memory (not shown) and/or a processor (not shown) and can be, for example, a computing device (e.g., a personal computer) and/or a wireless device (e.g., a PDA). The content aggregation point 342 and the content aggregation point 352 can collectively be referred to as content aggregation points 390. The network entity 350 and the network entity 340 can collectively be referred to as network entities 360.

Widget 314 and widget 318 can be served to content aggregation point 352 and content aggregation point 342, respectively, from widget server 310. Widget 316 can be served to content aggregation point 352 from widget server 320. Each widget from the widgets 380 can be served in response to a request defined in response to a reference (not shown) to, for example, the widget being accessed at the content aggregation point. In some embodiments, the reference can also be referred to as a link. For example, widget 314 can be served to network entity 350 for execution within content aggregation point 352 in response to a reference to widget 314 being accessed at content aggregation point 352. In some embodiments, reference can be automatically accessed when a portion of content aggregation point 352 is accessed. In some embodiments, the reference can be accessed in response to, for example, a user-triggered interaction via a user-interface (not shown) associated with the network entity 350.

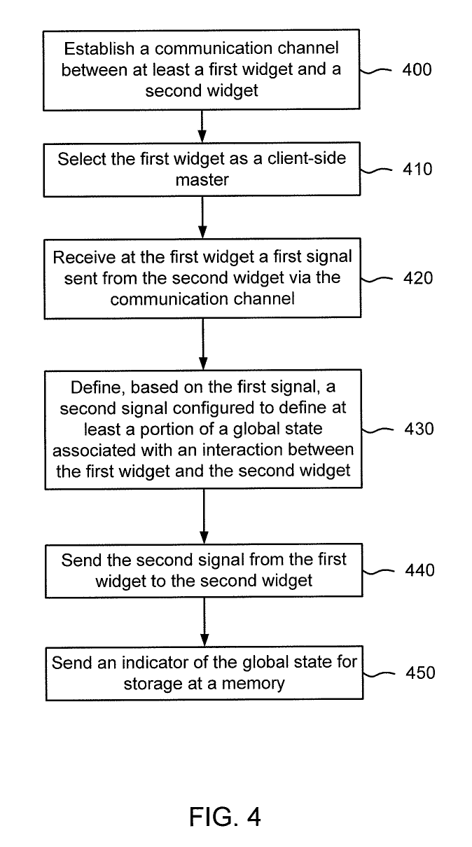

FIG. 4 is a flowchart that illustrates a method related to client-side master widget selection and operation, according to an embodiment. As shown in FIG. 4, a communication channel between at least a first widget and a second widget is established at 400. In some embodiments, the communication channel can be, for example, a communication channel that is private to the first widget and the second widget, and cannot be joined by another widget. In some embodiments, the communication channel be a semi-private communication channel a specified widget or a publicly available communication channel that can be joined by any widget in addition to the first widget and the second widget. In some embodiments, the communication channel can be configured to operate as an order bus.

In some embodiments, the first widget and the second widget can be configured to execute at one or more content aggregation points that can be associated with one or more network entities. In some embodiments, the first widget and/or the second widget can be a virally spread widget.

The first widget is selected as a client-side master at 410. The first widget can be selected to operate as the client-side master based on one or more conditions. For example, the first widget can be selected to operate as the client-side master based on the first widget being a specified type of widget (e.g., a java-based widget, a widget that includes a specified application).

The first widget receives a first signal sent from the second widget via the communication channel at 420. The first signal can be an inter-widget signal and can be related to a local state of the second widget. The first signal can be transmitted in response to a user-triggered interaction with the second widget.

A second signal configured to define at least a portion of a global state associated with an interaction between the first widget and the second widget is defined based on the first signal at 430. For example, the second signal can be an inter-widget signal that includes information related to the global state, which is defined based on the local state. In some embodiments, the first signal can be a master signal that includes a master flag that can be used to identify the signal as a master signal.

The second signal is sent from the first widget to the second widget at 440 and an indicator of the global state is sent for storage at a memory at 450. In some embodiments, the second signal can be broadcast from the first widget to the second widget, or can be unicast from the first widget to the second widget. The global state can be stored at a memory local to the first widget or at a memory location where the global state can be persistently maintained even if the first widget, which is the client-side master widget, were to become unavailable, or if a different widget (e.g., the second widget) were selected to function as the client-side master widget.

In some embodiments, portions of the flowchart can be performed in a different order. For example, in some embodiments, the second signal can be sent from the first widget to the second widget after the indicator of the global state is sent for storage at the memory.

In one embodiment, a method includes receiving at a first widget executing at a first client a first signal sent from a second widget executing at a second client. The first signal can be associated with an interactive session between at least the first widget and the second widget. The first widget can be selected to operate as a client-side master. The method can also include defining at the first widget, and based on the first signal, a second signal having a master flag. The second signal can be sent from the first widget to the second widget.

In some embodiments, the second signal can be configured to define at least a portion of a global state of the interactive session. The receiving can include receiving via a communication channel established between at least the first client and the second client. In some embodiments, the first widget can be a virally spread widget executing at a content aggregation point associated with the first client.

In some embodiments, the first widget can be executing within a first content aggregation point at the first client. The first widget can be virally spread from a second content aggregation point. In some embodiments, the second signal can be configured to define at least a portion of a global state of the interactive session. The method can also include sending an indicator of the global state for storage at a memory of the first client.

In some embodiments, the second signal can be configured to define at least a portion of a global state of the interactive session. The method can also include sending an indicator of the global state to a global channel host such that the state can be stored and can be retrieved from the global channel host by a third widget selected as the client-side master.

In some embodiments, at least one of the first signal or the second signal can be broadcast over a communication channel to a third widget. In some embodiments, the first widget can be configured to operate as the client-side master based on a function received at the first client from a global channel host in response to a reference to the first widget being accessed at a content aggregation point associated with the first client.

In some embodiments, the method can also include managing a global order of a plurality of signals transmitted using the communication channel such that the communication channel functions as an ordered bus. The first signal can be included in the plurality of signals. In some embodiments, the method can also include defining a global order of a plurality of signals sent from the second widget and a third widget via the communication channel. The first signal can be included in the plurality of signals. The plurality of signals can be associated with the interactive session.

In some embodiments, the method can also include sending an indicator to the second widget identifying the first widget as the client-side master. In some embodiments, the first widget can be selected to operate as an exclusive client-side master of the interactive session after a third widget has operated as the exclusive client-side master. In some embodiments, the first widget can be selected to operate as the client-side master based on a master selection criteria. In some embodiments, the communication channel can be established by a global channel host in response to a request defined by at least one of the first widget or the second widget.

Some embodiments relate to a computer storage product with a computer-readable medium (also can be referred to as a processor-readable medium) having instructions or computer code thereon for performing various computer-implemented operations. The media and computer code (also can be referred to as code) may be those specially designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; and hardware devices that are specially configured to store and execute program code, such as Application-Specific Integrated Circuits (ASICs), Programmable Logic Devices (PLDs), and Read-Only Memory (ROM) and Random-Access Memory (RAM) devices. Examples of computer code include, but are not limited to, micro-code or micro-instructions, machine instructions, such as produced by a compiler, and files containing higher-level instructions that are executed by a computer using an interpreter. For example, embodiments may be implemented using Java, C++, or other object-oriented programming language and development tools. Additional examples of computer code include, but are not limited to, control signals, encrypted code, and compressed code.

In conclusion, among other things, methods and apparatus related to inter-widget communication have been described. While various embodiments have been described above, it should be understood that they have been presented by way of example only, and various changes in form and details may be made. For example, the embodiments described herein can include various combinations and/or sub-combinations of the functions, components and/or features of the different embodiments described. For example, although many of the embodiments were discussed in connection with an inter-widget communication session, the embodiments can be applied to any type of inter-widget interactive session.

What is claimed is:

1. A processor-readable medium storing code representing instructions that when executed by a processor cause the processor to:
receive at a first widget executing at a first client a first signal sent from a second widget executing at a second client, the first signal being associated with an interactive session between at least the first widget and the second widget, the first widget being selected to operate as a client-side master; and
define at the first widget, and based on the first signal, a second signal having a master flag, the second signal being sent from the first widget to the second widget.

2. The processor-readable medium claim 1, wherein the second signal is configured to define at least a portion of a global state of the interactive session, the receiving includes receiving via a communication channel established between at least the first client and the second client.

3. The processor-readable medium claim 1, wherein the first widget is a virally spread widget executing at a content aggregation point associated with the first client.

4. The processor-readable medium claim 1, wherein the first widget is executing within a first content aggregation point at the first client, the first widget is virally spread from a second content aggregation point

5. The processor-readable medium claim 1, wherein the second signal is configured to define at least a portion of a global state of the interactive session,
the processor-readable medium, further storing code representing instructions that when executed by the processor cause the processor to:
send an indicator of the global state for storage at a memory of the first client.

6. The processor-readable medium claim 1, wherein the second signal is configured to define at least a portion of a global state of the interactive session.

7. The processor-readable medium claim 1, further storing code representing instructions that when executed by the processor cause the processor to:
send an indicator of the global state to a global channel host such that the state can be stored and can be retrieved from the global channel host by a third widget selected as the client-side master.

8. The processor-readable medium claim 1, wherein at least one of the first signal or the second signal is broadcast over a communication channel to a third widget.

9. The processor-readable medium claim 1, wherein the first widget is configured to operate as the client-side master based on a function received at the first client from a global channel host in response to a reference to the first widget being accessed at a content aggregation point associated with the first client.

10. The processor-readable medium claim 1, further storing code representing instructions that when executed by the processor cause the processor to:
manage a global order of a plurality of signals transmitted using the communication channel such that the communication channel functions as an ordered bus, the first signal being included in the plurality of signals.

11. The processor-readable medium claim 1, further storing code representing instructions that when executed by the processor cause the processor to:
define a global order of a plurality of signals sent from the second widget and a third widget via the communication channel, the first signal being included in the plurality of signals, the plurality of signals being associated with the interactive session.

12. The processor-readable medium claim 1, further storing code representing instructions that when executed by the processor cause the processor to:
send an indicator to the second widget identifying the first widget as the client-side master.

13. The processor-readable medium claim 1, wherein the first widget is selected to operate as an exclusive client-side master of the interactive session after a third widget has operated as the exclusive client-side master.

14. The processor-readable medium claim 1, wherein the first widget is selected to operate as the client-side master based on a master selection criteria.

15. The processor-readable medium claim 1, wherein the communication channel is established by a global channel host in response to a request defined by at least one of the first widget or the second widget.
